(19) United States
(12) Patent Application Publication
(10) Pub. No.: US 2013/0289204 A1
(43) Pub. Date: Oct. 31, 2013

(54) POLYIMIDE POWDER, POLYIMIDE SOLUTION, AND METHOD FOR PRODUCING POLYIMIDE POWDER

(71) Applicant: Chikao Kanazawa, Wakayama (JP)

(72) Inventor: Chikao Kanazawa, Wakayama (JP)

(21) Appl. No.: 13/979,597

(22) PCT Filed: Jan. 13, 2012
(86) PCT No.: PCT/JP2012/050586

§ 371 Date: Jul. 12, 2013

(30) Foreign Application Priority Data
Jan. 14, 2011 (JP) 2011-006102

(51) Int. Cl. C08G 73/10

(52) U.S. Cl. CPC C08G 73/1003
USPC 524/606; 528/322

(57) ABSTRACT

It is possible to provide polyimide powder which has an average size of 25 μm or less and is free from metal impurities which would otherwise be produced due to abrasion of a machine used for mechanical milling.

The polyimide powder is an aggregate of fine particles produced through precipitation of polyimide dissolved in a treatment solution containing a basic substance. A residual amount of alkali metal derived from the basic substance contained in the treatment solution is 1% or less of a total amount of the polyimide powder. It is possible to reduce bad effects due to an alkali metal residue and to prevent decomposition of polyimide by the alkali metal residue.

### TECHNICAL FIELD

The present invention relates to: polyimide powder and a polyimide solution which are available for a heat-resistant electric part, an automobile part, a mold for forming a screw of a glass bin, and an adhesive; and a method for producing the polyimide powder.

### BACKGROUND ART

In the past, to recycle and utilize a large number of polyimide films discarded as industrial waste, such polyimide films have been crushed into powder by a mill. Alternatively the waste polyimide films have been subjected to alkaline hydrolysis to obtain powder containing fine particles of low molecular weight compounds (see, Patent Document 1). For example, such powder is used by itself or by mixed with other resin as a molding material.

### CITATION LIST

### Patent Literature

[Patent Document 1] JP 2006-124530 A

### SUMMARY OF THE INVENTION

### Problems to be Solved by the Invention

The above method of mechanical milling can only provide powder having an average particle size (D₅₀) greater than 25 μm. Moreover, the powder obtained by mechanical milling may include metal impurities due to abrasion of a mill. In contrast, the alkaline hydrolysis described above can only provide powder consisting of fine particles of low molecular weight compounds because a large amount of polyimide is hydrolyzed.

In view of the above insufficiency, the present invention has an object to provide: polyimide powder which has an average particle size of 25 μm or less and is free from metal impurities which would otherwise be produced due to abrasion of a machine used for mechanical milling; and a method for producing the polyimide powder. Moreover, the present invention has an object to provide a polyimide solution containing the aforementioned polyimide powder.

### Means of Solving the Problems

Polyimide powder in accordance with the present invention is an aggregate of fine particles produced through precipitation of polyimide dissolved in a treatment solution containing a basic substance. The polyimide powder is characterized in that a residual amount of alkali metal derived from the basic substance contained in the treatment solution is 1% or less of a total amount of the polyimide powder.

In the polyimide powder in accordance with the present invention, polyamic acid contained in the fine particles is preferably polymerized by heating to form polyimide.

A polyimide solution in accordance with the present invention is characterized in that the polyimide solution is defined by a solution of the polyimide powder is dissolved or dispersed in a solvent.

The polyimide solution in accordance with the present invention preferably contains polyamic acid, which is derived from the fine particles of the polyimide powder, polymerizes by heating to form polyimide.

A method for producing polyimide powder in accordance with the present invention includes the steps of: dissolving polyimide in a treatment solution containing a basic substance; obtaining powder by precipitation of fine particles of polyimide by the means of mixing the resultant treatment solution with an acidic substance; and removing, from the powder, alkali metal derived from the basic substance until a residual amount of alkali metal is 1% or less of a total amount of the polyimide powder.

In the method for preparing polyimide powder in accordance with the present invention, it is preferable that the basic substance be potassium hydroxide.

### Effects of the Invention

According to the present invention, polyimide is dissolved in a treatment solution and then precipitated. Thus, it is possible to obtain polyimide powder having an average particle size of 25 μm or less, which is smaller than polyimide powder obtained by mechanical milling. Moreover, since the polyimide is not milled by a machine, it is possible to prevent contamination by metal impurities due to abrasion of the machine. Furthermore, a residual amount of an alkali metal is 1% or less of a total amount of the polyimide powder. Hence, it is possible to reduce bad effects due to an alkali metal residue, and to prevent decomposition of polyimide in the fine particles due to the alkali metal residue, and to prevent a decrease in molecular weight of compounds in the fine particles, and to prevent breakage of polymerization of polyamic acid in the fine particles. Thus, it is possible to obtain powder having a high content of polyimide.

### BRIEF DESCRIPTION OF THE DRAWINGS

FIG. 1A shows a chemical formula representing a compound contained in polyimide prepared as a raw material in accordance with the present invention,

FIG. 1B shows chemical formulae representing compounds contained in the polyimide powder before heated,

FIG. 1C shows chemical formulae representing compounds contained in the polyimide powder after heated,

FIG. 2A is a chart illustrating a DTA curve and a Tg curve for the polyimide powder in accordance with the present invention before heated,

FIG. 2B is a chart illustrating a DSC curve for the above polyimide powder before heated,

FIG. 3A is a chart illustrating a DTA curve and a Tg curve for the polyimide powder in accordance with the present invention after heated,

FIG. 3B is a chart illustrating a DSC curve for the above polyimide powder after heat treatment,

FIG. 4 is a chart showing a result on an infrared spectroscopy for Comparative Example 3,

FIG. 5 is a chart showing a result on an infrared spectroscopy for Comparative Example 1,

FIG. 6 is a chart showing a result on an infrared spectroscopy for Comparative Example 2,

FIG. 7 is a chart showing a result on an infrared spectroscopy for Example 1,

FIG. 8 is a chart showing a result on an infrared spectroscopy tor Example 2 with heating time of 0 min,

FIG. 9 is a chart showing a result on an infrared spectroscopy for Example 2 with heating time of 30 min,

FIG. 10 is a chart showing a result on an infrared spectroscopy for Example 2 with heating time of 60 min,

FIG. 11 is a chart showing a particle size distribution of Example 1,

FIG. 12 is a chart showing a particle size distribution of Comparative 3, and

FIGS. 13A and 13B are images of Example 2 taken by a scanning electron microscope.

### DESCRIPTION OF THE EMBODIMENTS

Following description will be given with regard to embodiments in accordance with the present invention.

Polyimide powder in accordance with the present invention is an aggregate of fine particles produced through precipitators of polyimide which is dissolved (hydrolyzed) in a treatment solution. The fine particles of the polyimide powder contain polyamic acid. The polyimide powder has, for example, a particle size distribution in a range of 1 to 500 μm and an average particle size (median size: D₅₀) of 25 μm or less. Such powder having a desired particle size distribution may be collected by a sieve. Besides, mechanical milling cannot produce polyimide powder having an average particle size of 25 μm or less because a mill for the mechanical milling cannot give an enough force to a raw material such as polyimide film and a molded article. Moreover, the polyimide obtained by mechanical milling may include metal impurities due to abrasion of the mill. While, the polyimide powder in accordance with the present invention has an average particle size of 25 μm or less because the powder produced through chemical milling. Moreover, the polyimide powder in accordance with the present invention is never contaminated by metal impurities due to such abrasion. Note that, the average particle size and the particle size distribution described above are measured by a laser diffraction and scattering method with a particle size analyzer (e.g., Microtrack MT3300 available from NIKKISO CO., LTD.).

In the polyimide powder in accordance with the present invention, a residual amount of alkali metal, which is derived from a basic substance contained in the treatment solution for dissolving polyimide prepared as a raw material, is 1% or less of a total amount of the polyimide powder in weight. When the alkali metal in an amount of more than 1% of the total amount of the polyimide powder remains, hydrolysis of polyimide in the fine particles may proceed to cause a decrease in molecular weight of polyimide. For example, polyimide may be decomposed into a raw material for the polyimide such as pyromellitic dianhydride and 4,4′-diaminodiphenyl ether. Therefore, when a residual amount of the alkali metal is 1% or less of a total amount of the polyimide powder in weight, it is possible to prevent bad effects due to the alkali metal residue and hydrolysis of the fine particles caused by the alkali metal, and it is possible to achieve a decrease in the number of fine particles, of which molecular weight is lowered after precipitation. With using the polyimide powder in accordance with the present invention by itself or by mixed with other resin as a molding material, it is possible to reinforce the polyimide in the molding material. Therefore, the molded article which has higher heat resistance, higher strength, and higher wear-resistance can be obtained. Note that, the lower residual amount of alkali metal is preferable, so a lower limit of the residual amount of alkali metal is 0%.

The polyimide powder in accordance with the present invention is prepared as follows. First of all, polyimide, which is prepared as a raw material, is dissolved (hydrolyzed) in the treatment solution containing the basic substance. The basic substance may be selected at least one of an alkali metal and a salt containing an alkali metal. For example, the basic substance may be a strong basic substance such as potassium hydroxide and sodium hydroxide. Particularly, potassium hydroxide is preferable because it is possible to obtain the polyimide powder which has a color slightly different from that of the polyimide prepared as a raw material. As a solvent of the treatment solution, water or a solution prepared by mixing water with an organic solvent (e.g. glycerine) may be used. The treatment solution may be prepared by dissolving the basic substance into the solvent. In this regard, 10 to 50 parts by weight (preferably 10 to 40 parts by weight) of the basic substance may be dissolved in 100 parts by weight of the solvent. And the pH of the treatment solution may be set in a range of 10 to 14. Thus, the polyimide, which is a raw material, is dissolved well.

The polyimide as a raw material dissolved in the treatment solution is not particularly limited so long as it contains an imide bond in a repeating unit in a main chain. For example, the polyimide may be aromatic polyimide containing aromatic compound which is directly connected to imide bond. The polyimide as the raw material is not limited so long as it contains polyimide. For example, the polyimide as the raw material may be a material containing polyimide such as an industrial waste, which includes a defective product and a cutting waste or the like which are produced in a process of making the polyimide film, and a polyimide product waste. As for the raw material, the defective product and the cutting waste of the polyimide film, which contains less impurities, are preferable. The polyimide as a raw material is dissolved by soaking in a treatment solution. In this case, 40 to 120 parts by weight (preferably 40 to 80 parts by weight) of polyimide may be added in the treatment solution containing 100 parts by weight of the solvent. The temperature of the treatment solution may be in a range of 70 to 100° C., and preferably in a range of 70 to 90° C. And a treatment time may be in a range of 50 to 100 min. Stirring is conducted if necessary. Thus, polyimide as a raw material is dissolved well.

Thereafter, the treatment solution in which the polyimide as a raw material is dissolved is cooled (for about 10 min) if necessary. Then, an acidic substance is added into the treatment solution so that the treatment solution is neutralized and the fine particles of the dissolved polyimide is precipitated. The acidic substance may be selected from a strong acid (e.g., hydrochloric acid) and a weak acid (e.g., phosphric acid). The additive amount of the acidic substance may be in a range of 10 to 80 parts by weight and preferably in a range of 10 to 40 parts by weight relative to the 100 parts by weight of the solvent in the treatment solution. Thus, the precipitation of the fine particles of polyimide is successfully conducted. Further, the addition of the acidic substance may allow the treatment solution to have a pH in a range of 4 to 6.

Subsequently, the neutralized treatment solution including the precipitated fine particles of polyimide is filtered in order to obtain therefrom powder of a solid content containing the fine particles of polyimide. The filteration is conducted by use of a filter press, for example. The filteration separates the solid content containing the fine particles of polyimide from a liquid content containing alkali metal derived from the basic substance. Next, the obtained powder of fine particles of polyimide is washed with water. This water washing process may remove (reduce) the alkali metal remaining on the polyimide powder (for example, attached to the fine particles) derived from the basic substance. In the water washing process, adding the solid content obtained through the filtration into water and stirring the resultant solution are treated as one step, and this step may be repeated (e.g. 5 to 10 times) until the residual amount of the alkali metal is 1% or less. Concretely, for example, the water washing process is performed by repeating six times a step of mixing 50 parts by weight of the obtained powder of the fine particles of polyimide with 100 L of water and subsequently stirring the resultant solution at 60° C. for 30 min.

After that, the polyimide powder is dehydrated under vacuum and dried at 70 to 80° C. for about 12 hours to obtain the polyimide powder having a water content of 0.5% or less. The polyimide powder has the average particle size of 25 μm or less. The polyimide powder obtained by the above method may be used by itself or by mixed with other resin or the like as a molding material. For example, poly tetrafluoroethylene resin powder having a particle size in a range of 10 to 100 μm and the polyimide powder in an amount of 10 to 30 weight % of poly tetrafluoroethylene resin powder are mixed. With molding this mixture by heating and pressing the same at 300 to 360° C. under 10 to 50 MPa, an article such as a sheet and a molding article (for example, a slide member for a rotor bearing) can be obtained. In another example, 50 weight % of the above polyimide powder, 40 weight % of thermosetting phenolic resin, and 10 weight % of carbonblack are mixed to form a compound. Molding the compound by heating and pressing the same at 190 to 250° C. under 10 to 20 MPa for 30 to 45 min may produce a molding article available for a heat-resistant electric part, an automobile part, and a mold for a screw of a glass bin. Also, the above polyimide powder, carbon fiber, and powder of tetrafluoroethylene are mixed. With molding this mixture by heating and pressing the same, a molding article having heat resistance and shock resistance can be obtained.

Moreover, it is possible to prepare a polyimide solution by dissolving or dispersing the above polyimide powder in a solvent. The polyimide solution may be used as an adhesive and a coating. The polyimide solution is particularly used as an adhesive, which bonds strongly metal members to each other and has high heat resistance. As the solvent for the polyimide solution, an aprotic polar solvent such as N-methylpyrrolidone (NMP) and dimethylformamide (DMF) can be used. The polyimide solution in accordance with the present invention is prepared by blending 100 parts by weight of the polyimide powder and 1 to 400 parts by weight (preferably 40 to 300 parts by weight) of the solvent.

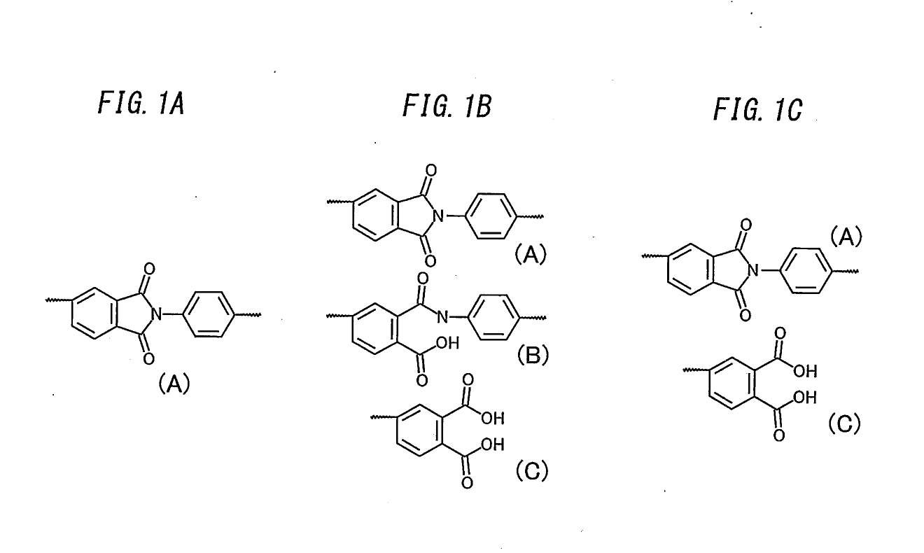

The fine particles which constitute the polyimide powder in accordance with the present invention include: polyimide; polyamic acid which is a precursor of polyimide; and other decompositions. In other words, polyimide as a raw material before hydrolyzation in the treatment solution, for example, has a repeating unit represented by the formula (A) as shown in FIG. 1A. With powderizing this polyimide through the above process, it is possible to obtain fine particles including polyimide having a repeating unit represented by the formula (A) in FIG. 1B, polyamic acid having a repeating unit represented by the formula (B), and other decompositions such as represented by the formula (C).

The fine particles which constitute the polyimide powder in accordance with the present invention may have an increased content of polyimide when heated. This is presumably caused by the fact that polyamic acid in the fine particles polymerizes to polyimide and imidization from polyamic acid proceeds. Therefore, after heated, the fine particles of the polyimide powder have an increased content of polyimide having a repeating unit represented by the formula (A) in FIG. 1C. Polymerization of polyamic acid starts around 160° C., and, even when the heating temperature is 230° C. or more, the polymerization is hardly promoted and polymerization degree is hardly increased. Therefore, to increase a content of polyimide, the fine particles of the polyimide powder are preferably heated at 160 to 230° C. Time for heating above is not limited, but it is preferable that the above temperature be maintained for 30 to 60 min. Thus, inadequate polymerization of the polyamic acid is less likely to occur and extra (excess) heating can be avoided.

The heating the fine particles is conducted by heating the polyimide powder. In this case, it is possible to obtain polyimide powder containing a large amount of the fine particles having an increased content of polyimide. This heated polyimide powder may be blended into resin material and cement material in order to serve as an aggregate for cement. Moreover, polyimide powder before heated is used for preparing such a molding article described above. After preparing the molding article, the polyamic acid derived from the fine particles of the polyimide powder may polymerize in the molding article by heating the molding article. Thus, it is possible to obtain the molding article having improved heat-resistance owing to an increased content of polyimide. Moreover the polyimide powder before heated is used for preparing such a polyimide solution described above. After preparing the polyimide solution, polyamic acid in the polyimide solution derived from the fine particles of the polyimide powder may polymerize by heating the polyimide solution. In this case, a film, a lump, or the like consisting of a compound in the polyimide solution is formed while the solvent in the polyimide solution is evaporated. The film or the lump has an improved high heat resistance due to an increased content of polyimide.

### EXAMPLES

Concrete description will be given with regard to Examples in accordance with the present invention.

### Example 1

Polyimide film produced by DU PONT-TORAY CO., LTD. (registered trademark: Kapton) was used as polyimide as a raw material.

Potassium hydroxide (KOH) was used as the basic substance. 40 parts by weight of KOH was dissolved in 100 parts by weight of water to prepare the treatment solution containing the basic substance. The pH of the treatment solution was 14.

Thereafter, 100 parts by weight of polyimide as a raw material relative to 100 parts by weight of water in the treatment solution was added and dissolved in the treatment solution. Thus, the treatment solution in which polyimide was dissolved by alkaline hydrolysis was obtained. This dissolution was conducted at 80° C. for 90 min.

Subsequently, by adding an acidic substance into the treatment solution in which the polyimide was dissolved, the treatment solution was neutralized and fine particles of the dissolved polyimide were precipitated in the treatment solution. For example, hydrochloric acid (HCl) was used as the acidic substance and 40 parts by weight of 38% hydrochloric acid was added into the treatment solution containing 100 parts by weight of water. This neutralization process was conducted under stirring until the neutralization was completed.

Next, the solid content was obtained by filteration from the treatment solution containing the precipitated fine particles of polyimide. Then, the obtained solid content was washed with water. In this water washing process, a step of adding the obtained solid content into water and subsequently stirring the resultant solution at ambient temperature for 20 min was repeated six times. Then, the solid content washed with water was dehydrated under a reduced pressure and dried at 70 to 80° C. for 12 hours, and thus polyimide powder having a water content of 0.5% or less was obtained.

### Example 2

Polyimide film produced by DU PONT-TORAY CO., LTD. (registered trademark: Kapton) was used as polyimide as a raw material.

Potassium hydroxide (KOH) was used as the basic substance. 20 parts by weight of KOH was dissolved in 50 parts by weight of water to prepare a treatment solution containing the basic substance. The pH of the treatment solution was 14.

Then, 50 parts by weight of polyimide as a raw material relative to 50 parts by weight of water contained in the treatment solution was added and dissolved in the treatment solution. Thus, the treatment solution in which polyimide was dissolved by alkaline hydrolysis was obtained. This dissolution was conducted at 95° C. for 90 min. Then, the treatment solution was cooled for 10 min.

Subsequently, by adding an acidic substance into the treatment solution in which the polyimide was dissolved, the treatment solution was neutralized and fine particles of the dissolved polyimide were precipitated in the treatment solution. Hydrochloric acid (HCl) was used as the acidic substance. 35 parts by weight of hydrochloric acid and 35 parts by weight of water were added into the treatment solution to 100 parts by weight of water contained in the treatment solution. This neutralization process was conducted under stirring until the neutralization was completed.

Next, the solid content was obtained from the treatment solution containing the precipitated fine particles of polyimide by filtering and by squeezing with a filter press for 30 min. Then, the obtained solid content was washed with water. This water washing process was performed by repeating six times a step of mixing 50 kg of the filterated solid content with 100 L of water and subsequently stirring the resultant solution at 60° C. in a vessel for 30 min. Then, the solid content washed with water was dried under a reduced pressure (almost absolute vacuum) for 48 hours, and thus polyimide powder having a water content of 0.5% or less was obtained.

### Example 3

A polyimide solution was prepared by dissolving the polyimide powder of Example 1 in a solvent. NMP was used as the solvent. Concretely, the polyimide having a solid concentration of 25% was obtained by blending 100 parts by weight of the polyimide powder and 300 parts by weight of the solvent.

### Example 4

Example 4 was different from Example 3 in that the polyimide powder of Example 2 was used to prepare a polyimide solution instead of the polyimide powder of Example 1. Other conditions were same as those in Example 8.

### Comparative Example 1

Comparative Example 1 was different from Example 1 in that the above step in the water washing process was repeated three times. The polyimide powder was prepared while other conditions were same as those in Examples.

### Comparative Example 2

Comparative Example 2 was different from as Example 1 in that the water washing process was not carried out. The polyimide powder was prepared while other conditions are same as those in Examples.

### Comparative Example 3

Polyimide film, which was used in Example 1, was crushed by mechanical milling. A vibrating mill (available from Chuo Kakouki Co. LTD.) was used as a mill for mechanical milling.

### Comparative Example 4

Comparative Example 4 was different from Example 3 in that the polyimide powder of Comparative Example 1 was used to prepare a polyimide solution instead of the polyimide powder of Example 1. Other conditions were same as those in Example 3.

### Comparative Example 5

Comparative Example 4 was different from Example 3 in that the polyimide powder of Comparative Example 2 was used to prepare a polyimide solution instead of the polyimide powder of Example 1. Other conditions for preparing the polyimide solution were same as those in Example 3.

### Measurement of an Imidization Rate

10 parts by weight of the polyimide powder obtained in Examples 1 and 2 and Comparative Examples 1 and 2 were heated. Heating temperature was selected from 160° C. and 200° C., and heating time was selected from 0 min, 30 min, and 60 min for each heating temperature. Then, measurement of an imidization rate was made on the polyimide powder after heated at the selected heating temperature for the selected heating time. In the measurement of the imidization rate, infrared spectroscopy (IR) was conducted by use of FT/IR-670Plus (available from JASCO Corporation) and a chart given by the infrared spectroscopy was analyzed. Then, the imidization rate was calculated according to a formula represented by (absorbance of an imide group (1.375 cm⁻¹ in IR))/(absorbance of benzene ring (1500 cm⁻¹ in IR)?100. The results are shown in the Table 1.

TABLE 1

| | | 0 min | 30 min | 60 min |
|---|---|---|---|---|
| Example 1 | 160° C. | 44.1% | 47.5% | 50.5% |
| | 200° C. | 44.1% | 59.8% | 67.0% |
| Example 2 | 160° C. | 44.9% | 48.1% | 51.5% |
| | 200° C. | 44.9% | 60.3% | 67.9% |
| Comparative | 160° C. | 44.5% | became black | became black |
| Example 1 | 200° C. | 44.5% | became black | became black |
| Comparative | 160° C. | 44.1% | became black | became black |
| Example 2 | 200° C. | 44.1% | became black | became black |
| Comparative | 160° C. | 89.7% | 90.4% | 90.1% |
| Example 3 | 200° C. | 89.0% | 90.1% | 90.3% |

As apparent from Table 1, as for each of Examples 1 and 2, the imidization rate tends to increase with an increase in heating time. This would be presumably caused by the fact that the content of polyimide increases because polyamic acid in the polyimide powder polymerizes to form polyimide when heated. In contrast, as for each of Comparative Examples 1 and 2, since impurities were not removed sufficiently and the imidization was insufficient, the polyimide powder became black. Note that, the polyimide powder of Comparative Example 3 was prepared by mechanical milling. Therefore, the imidization rate was relatively high even before the polyimide powder was heated, and heating did not promote polymerization.

### Differential Thermal Analysis (DTA), Differential Scanning Calorimetry (DSC), Theremo Gravimetry (Tg)

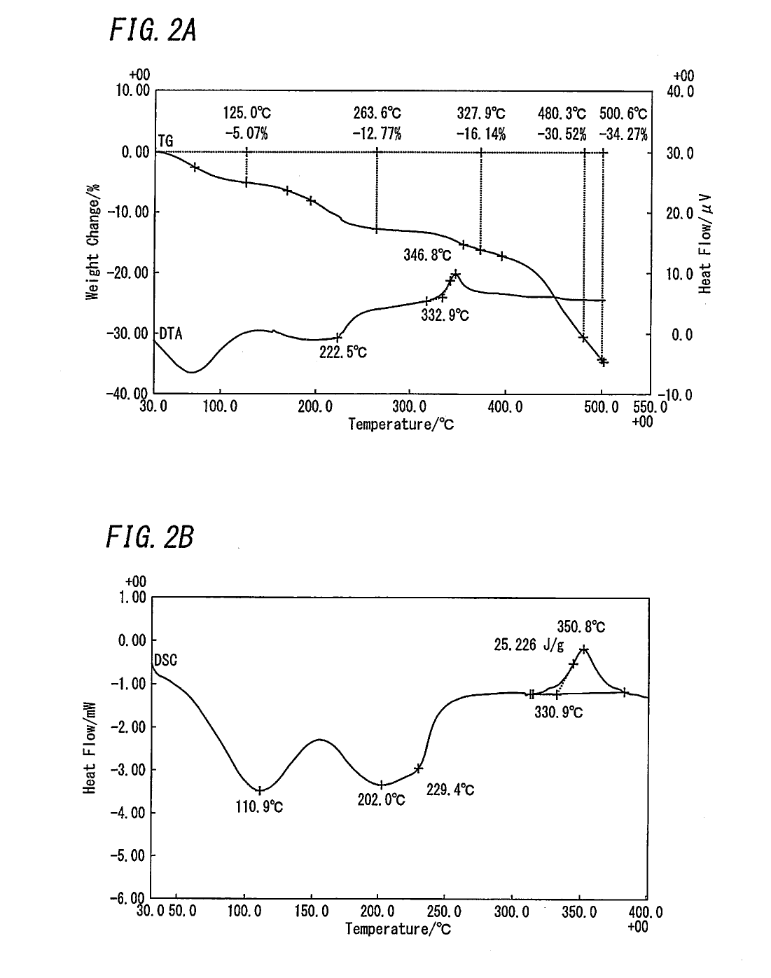

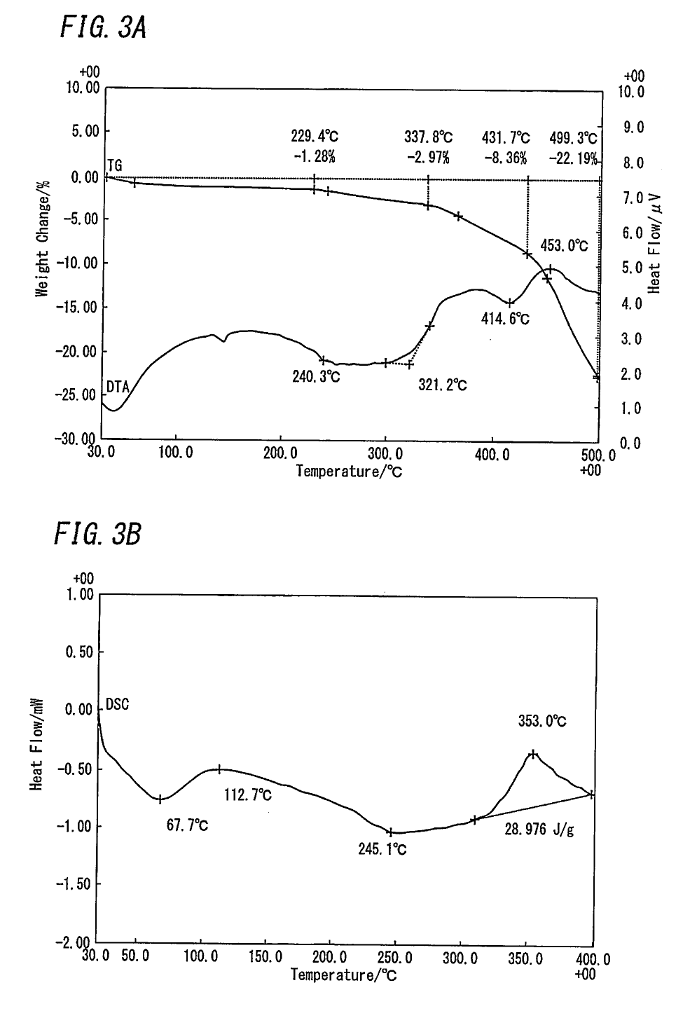

DTA, Tg, and DSC were conducted on each of the polyimide powder of Example 2 before heated and the polyimide powder of Example 2 after heated (at 200° C. for 60 min). As measurement equipment, “DSC8230” available from Rigaku Corporation was used. Measurement was conducted under nitrogen atmosphere (Flow rate 20 ml/min) and a heating rate was 10.0° C./min. FIG. 2A shows a DTA curve and a Tg curve of the polyimide powder before heated, and FIG. 2B shows a DSC curve of the polyimide powder before heated. FIG. 3A shows a DTA curve and a Tg curve of the polyimide powder after heated and FIG. 3B shows a DSC curve of the polyimide powder after heated.

### Infrared Spectroscopy

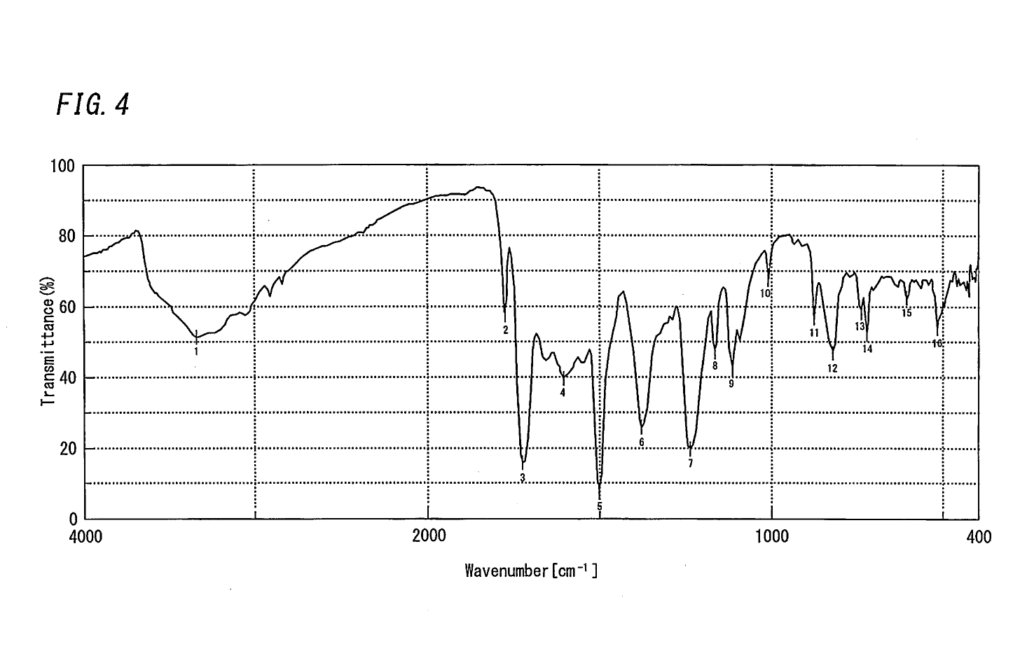

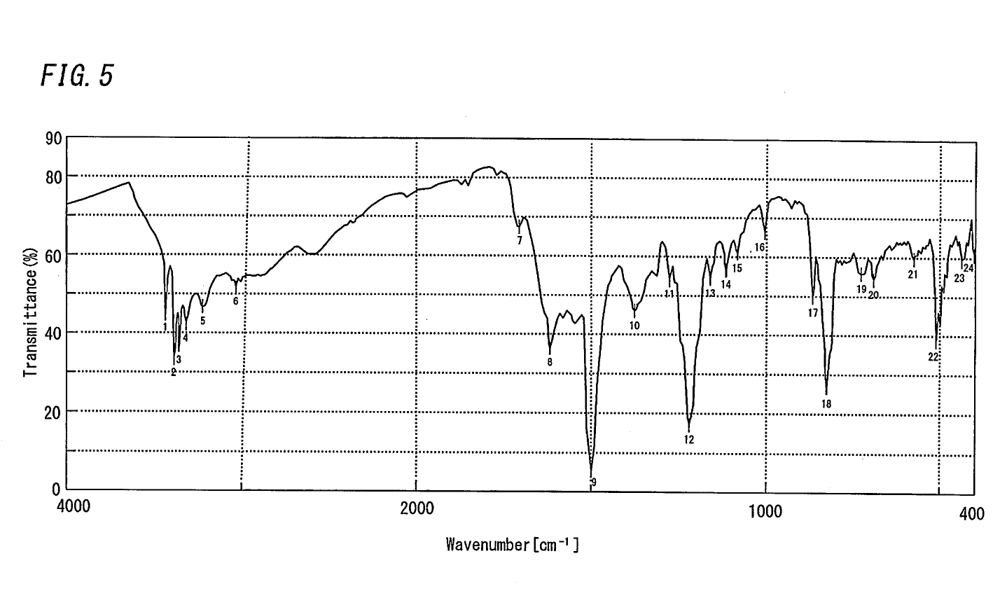

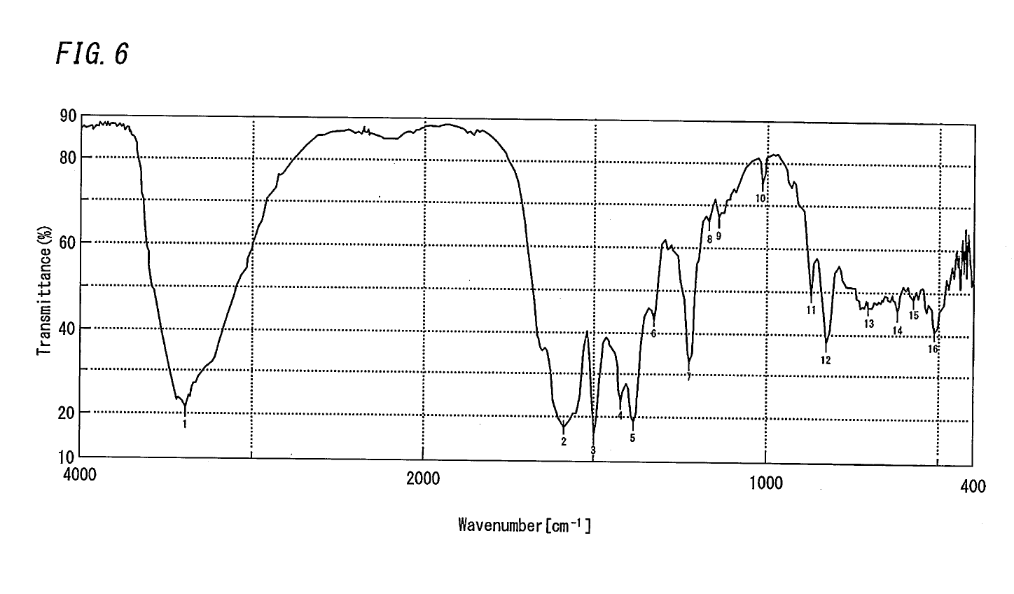

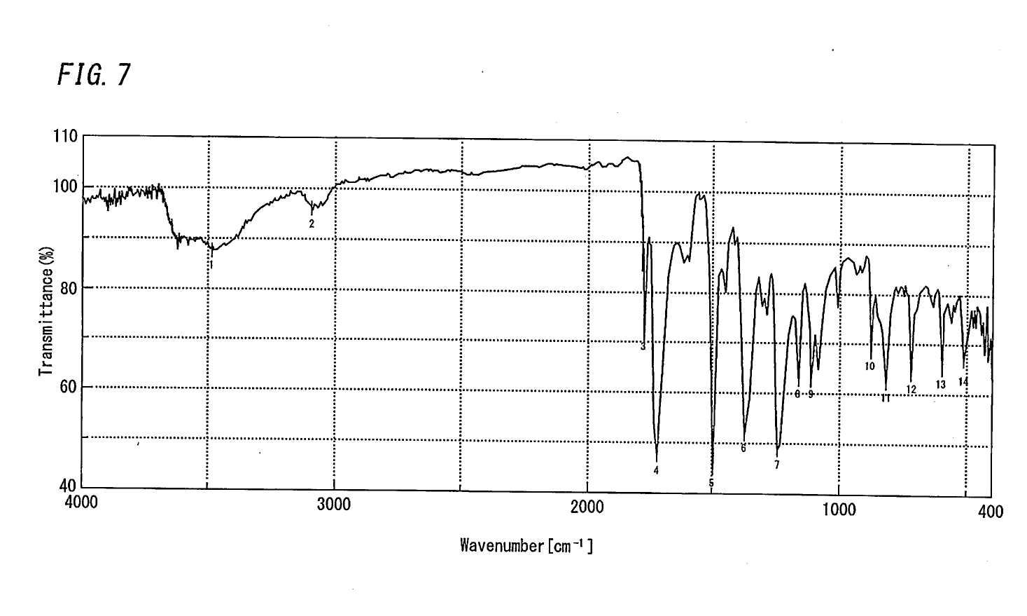

Infrared spectroscopy (IR) was conducted on Example 1 and Comparative Examples 1 to 3. In this regard, FT/IR-670Plus available from JASCO Corporation was used as a measurement device. FIGS. 4 to 7 are charts showing IR spectra respectively. The result regarding Example 1 shows peaks 3 and 5 derived from polyimide, and the result regarding Comparative Example 3 obtained by means of mechanical milling shows peaks 4 and 5 which are similar to peaks 3 and 5 observed in Example 1. Thus, it is concluded that the powder of the fine particles containing polyimide was obtained in Example 1. In contrast, the results regarding Comparative Examples 1 and 2 do not show intense peaks derived from polyimide. This presumably indicates that the precipitated fine particles in Comparative examples 1 and 2 contain a component different from polyimide (for example, fine particles of low molecular weight compound formed by hydrolysis of polyimide) and a content of the component is higher than that of polyimide.

Also an residual amount of potassium regarding each of Example 1 and Comparative Examples 1 and 2 was measured by infrared spectroscopy. Regarding Example 1, the residual amount of potassium is 1% of a total amount of the polyimide powder. Regarding Comparative Example 1, the residual amount of potassium is 3% of a total amount of the polyimide powder. Regarding Comparative Example 2, the residual amount of potassium is 10% of a total amount of the polyimide powder.

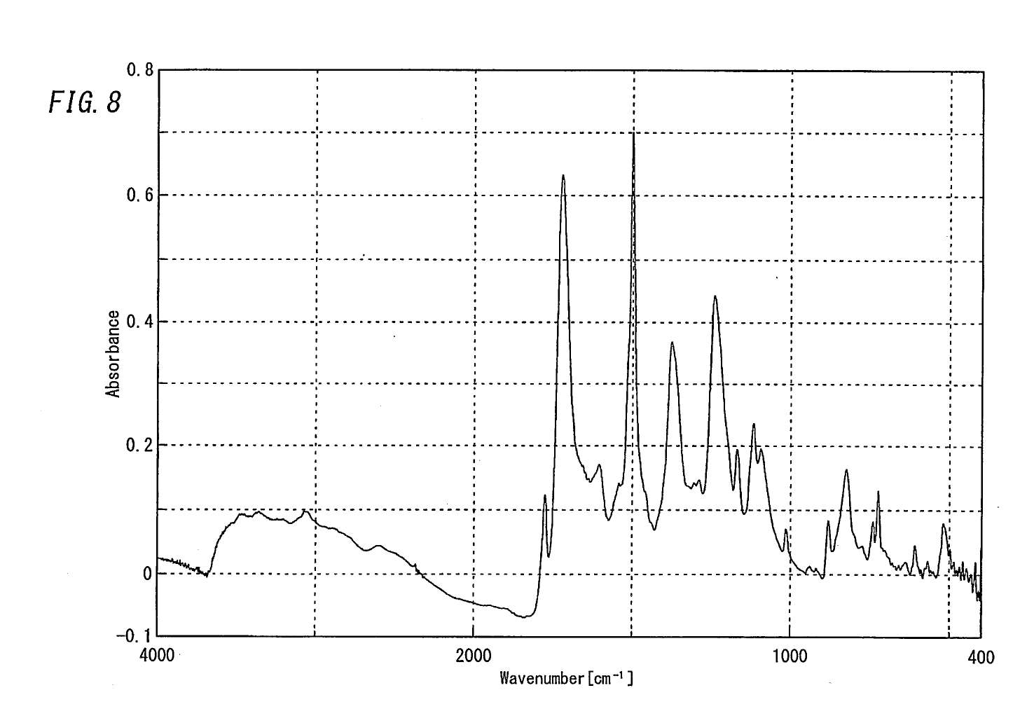

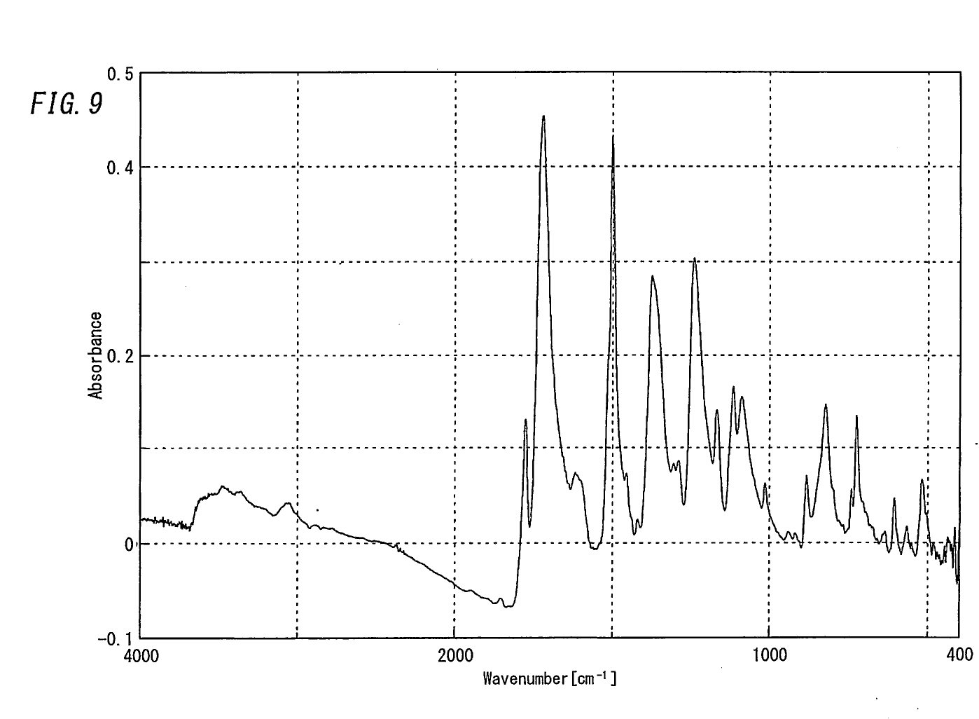

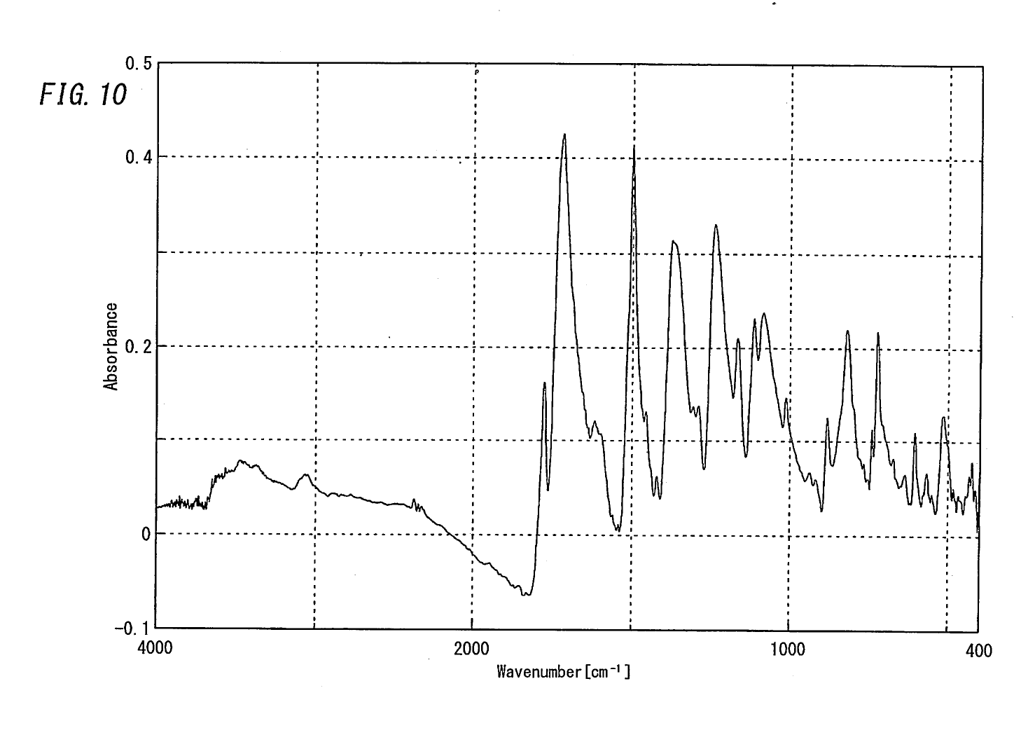

10 parts by weight of the polyimide powder of Example 2 was heated at 200° C. Heating time is selected from 0 min, 30 min, and 60 min. Infrared spectroscopy (IR) was performed, in a similar manner as above, on the polyimide powder heated for the selected heating time. FIG. 8 shows a result (chart) concerning the polyimide powder heated for the heating time of 0 min, and FIG. 9 shows a result concerning the polyimide powder heated for the heating time of 30 min. and FIG. 10 shows a result concerning the polyimide powder heated for the heating time of 60 min. According to comparison between these results, the charts corresponding to the heating time of 30 min and 60 min show absorbance around 1375 cm⁻¹ and absorbance around 1500 cm⁻¹ which are lower than those in the chart corresponding to heating time of 0 min. Therefore, it is concluded that heating promotes imidization of the polyimide powder.

### Measurement of a Particle Size Distribution

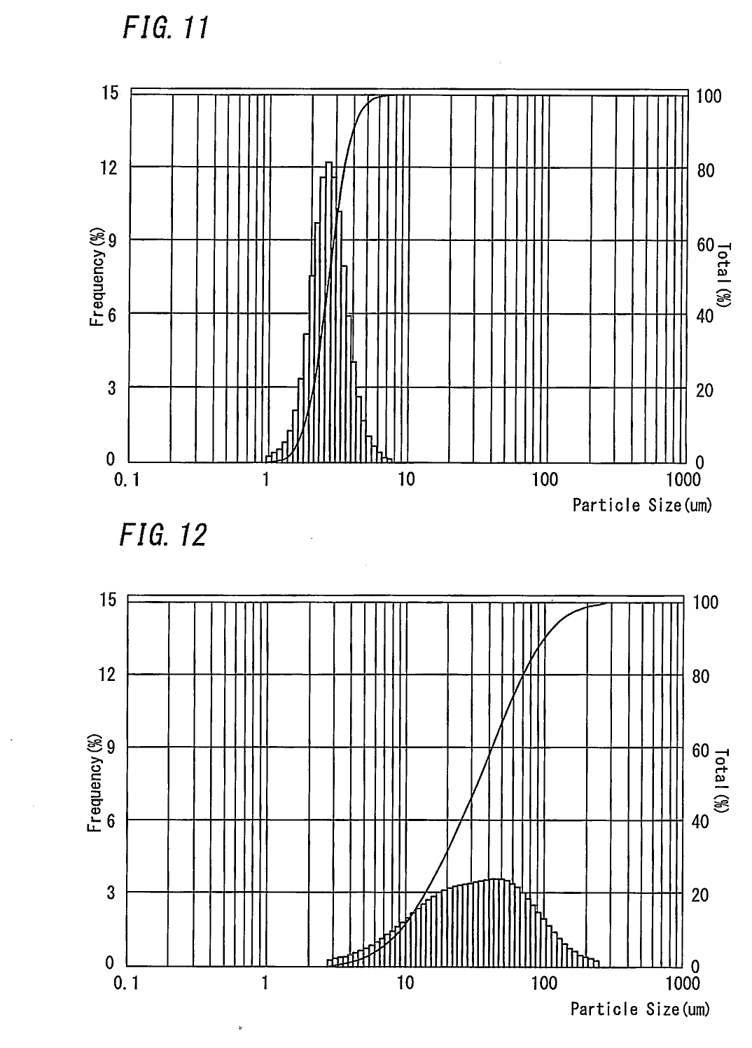

The average particle size and the particle size distribution regarding Example 1 and Comparative Example 3 were measured by a laser diffraction and scattering method with Microtrack MT3300 available from NIKKISO CO., LTD. With regard to Example, as shown in FIG. 11, the particle size distribution was in a range of 1.06 μm to 7.78 μm and the average particle size (D₅₀) was 2.67 μm. While, with regard to Comparative Example 3, as shown in FIG. 12, the particle size distribution was in a range of 3.00 μm to 249.0 μm and the average particle size (D₅₀) was 32.16 μm. Thus, it is concluded that Example 1 gives polyimide powder having a smaller average particle size and a narrower particle size distribution than those of Comparative Example 3.

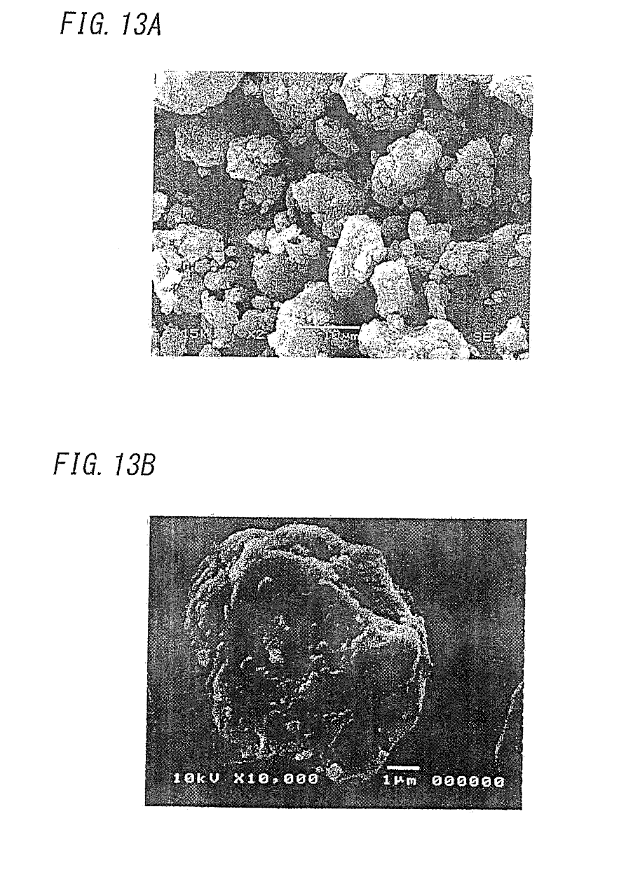

FIGS. 13A and 13B show images of Example 2 taken with a scanning electron microscope. These images indicate the fine particles of the polyimide powder are smaller than 10 μm.

### Test for Adhesiveness

Each of polyimide solutions prepared in Examples 3 and 4 and Comparative Examples 4 and 5 was used as an adhesive. The test was conducted in conformity with JIS K6849 (test method for adhesive strength in a tensile direction for an adhesive), for example. Each of the Examples 3 and 4 enabled firm adhesion because imidization is promoted by heating. In contrast, each of the Comparative Examples 4 and 5 showed lower adhesive strength than Examples 3 and 4 because imidization hardly proceeds.

1. Polyimide powder comprising an aggregate of fine particles produced through precipitation of polyimide dissolved in a treatment solution containing a basic substance, wherein
a residual amount of alkali metal derived from the basic substance contained in the treatment solution is 1% or less of a total amount of the polyimide powder.

2. The polyimide powder according to claim 1,
wherein polyamic acid contained in the fine particles is polymerized by heating to form polyimide.

3. A polyimide solution defined by a solution of the polyimide powder according to claim 1 dissolved or dispersed in a solvent.

4. A method for producing polyimide powder comprising the steps of:
dissolving polyimide in a treatment solution containing a basic substance;
obtaining powder by precipitation of fine particles of polyimide by the means of mixing the resultant treatment solution with an acidic substance; and
removing, from the powder, alkali metal derived from the basic substance until a residual amount of alkali metal is 1% or less of a total amount of the polyimide powder.

5. The method for producing polyimide powder according to claim 4,
wherein the basic substance is potassium hydroxide.

6. A polyimide solution defined by a solution of the polyimide powder according to claim 2 dissolved or dispersed in a solvent.
